(19) United States
(12) Patent Application Publication
(10) Pub. No.: US 2009/0197076 A1
(43) Pub. Date: Aug. 6, 2009

(54) Enamel Composition, Coated Products and Methods

(76) Inventors: Lihua Xie, Shenzhen (CN); Jian Sun, Shenzhen (CN); Qiang Guo, Shenzhen (CN); Liang Chen, Shenzhen (CN)

Correspondence Address: BRINKS HOFER GILSON & LIONE, P.O. BOX 10395, CHICAGO, IL, 60610, US

(21) Appl. No.: 12/364,098

(22) Filed: Feb. 2, 2009

(30) Foreign Application Priority Data
Feb. 2, 2008 (CN) 200810006866.8

(51) Int. Cl. B32B 17/06; B05D 3/02; C25D 13/02

(52) U.S. Cl. 428/334; 428/433; 427/397.7; 204/509; 501/14

(57) ABSTRACT

In one aspect, the invention is an enamel composition comprising zinc oxide, diboron trioxide, zirconium dioxide, silicon oxide, sodium oxide, barium oxide, lithium oxide, at least one of aluminum oxide and aluminum oxide precursor compounds that form aluminum oxide upon sintering, and at least one of calcium oxide and calcium oxide precursor compounds that form calcium oxide upon sintering. In another aspect, the invention is a product coated with an enamel layer. In yet another aspect, the invention is a method of coating a product.

The present application claims priority to Chinese Patent Application No. 200810006866.8, filed Feb. 2, 2008, the entirety of which is hereby incorporated by reference.

### FIELD OF THE DISCLOSURE

The present disclosure relates to an enamel composition, a coated product prepared from the enamel composition and methods for preparing the same.

### BACKGROUND OF THE DISCLOSURE

The exterior appearances of electronic devices are important for many users. Favorable features of the appearances include multiple, bright and fade-resistant colors, metallic textures, and smooth surfaces. Approaches to achieve these effects involve applying an enamel layer on the substrate. The wear-resistance, corrosion-resistance, and strong adhesion to the substrate are desired characters for the enamel layer.

Patent CN 1724430A disclosed a method for protecting a surface of a high-temperature titanium alloy. An antioxidation enamel was applied onto a substrate by electrophoresis. The composition of the enamel includes: 6.5-10.2% of Al₂O₃; 2.7-4.2% of ZrO₂; 5.3-8.9% of ZnO; 2.7-4.3% of B₂O₃; 1.9-3.8% of CaO; 1.9-3.6% of Na₂O; 1.0-2.0% of rare-earth oxides; 2.0-5.6% of Mg(NO₃)₂; 12.2-15.8% of ZrSiO₄; 5.2-8.0% of Na₂B₄O₇. The rest of the compositions are SiO₂ and other impurities.

### SUMMARY OF THE DISCLOSURE

In one aspect, an enamel composition comprises zinc oxide, diboron trioxide, zirconium dioxide, silicon oxide, sodium oxide, barium oxide, lithium oxide, at least one of aluminum oxide and aluminum oxide precursor compounds that form aluminum oxide upon sintering, and at least one of calcium oxide and calcium oxide precursor compounds that form calcium oxide upon sintering.

In another aspect, a coated product comprises a substrate having a surface; and an enamel layer on the surface of the substrate. The enamel layer comprises zinc oxide, diboron trioxide, zirconium dioxide, silicon oxide, sodium oxide, barium oxide, lithium oxide, aluminum oxide, and calcium oxide.

In yet another aspect, a method for coating a product comprises; applying an enamel composition to a surface of a substrate; and sintering the enamel composition to form an enamel layer on the substrate. The enamel layer comprises zinc oxide, diboron trioxide, zirconium dioxide, silicon oxide, sodium oxide, barium oxide, lithium oxide, aluminum oxide, and calcium oxide.

### DETAILED DESCRIPTION OF THE DISCLOSURE

It is noted that the term enamel composition is intended to have a relatively broad meaning, referring to various compositions that are employed to create, when sufficiently heated, an enamel-like substance, preferably in the form of a coating.

It is also noted that, unless noted otherwise, the term weight percent or its abbreviation wt % is intended to mean the percent by weight of the oxides in the composition.

The present disclosure provides an enamel composition. The composition comprises zinc oxide, diboron trioxide, zirconium dioxide, silicon oxide, sodium oxide, barium oxide, lithium oxide, at least one of aluminum oxide and aluminum oxide precursor compounds that can be converted into aluminum oxide by sintering, and at least one of calcium oxide and calcium oxide precursor compounds that can be converted into calcium oxide by sintering.

Preferably, the zinc oxide is about 5-8.5 wt %, the diboron trioxide is about 2.5-6.5 wt %, the zirconium dioxide is about 2.6-4.2 wt %, the silicon oxide is about 49-68 wt %, the sodium oxide is about 3.6-10.2 wt %, the barium oxide is about 6-10.5 wt %, the lithium oxide is about 2-10.5 wt %, the total amount of the aluminum oxide from either aluminum oxide or the aluminum oxide precursor compounds is about 5.6-11 wt %, and the total amount of the calcium oxide from either calcium oxide or the calcium oxide precursor compounds is about 1.8-3.6 wt %.

The oxides of the enamel composition can be in various forms. Preferably, the oxides are in the form of particles that are easily mixed. More preferably, the oxides are in the form of granules. Most preferably, at least some of the granules comprise one or more than one of the above-mentioned oxide compounds.

A preferred embodiment comprises zinc oxide granules, diboron trioxide granules, zirconium dioxide granules, at least one of silicon oxide granules and quartz granules, sodium oxide granules, barium oxide granules, lithium oxide granules, at least one of aluminum oxide granules and bauxite granules, and at least one of calcium oxide granules and calcium hydroxide granules. The granules can have a particle diameter of about 1-300 nm. Preferably, the particle diameter is about 1-100 nm.

Preferably, the enamel composition further comprises at least one of silver molybdate and zinc molybdate. The composition may have antibacterial effects against colibacillus, staphylococcus aureus and other bacterials. The containing of silver molybdate and zinc molybdate may improve binding force, wear-resistance and corrosion-resistance of the enamel materials. Also it may decrease the surface roughness of the enamel.

Base on the total amount of the composition, the preferred total amount of the silver molybdate and the zinc molybdate is about 0.1-0.3 wt %. When the composition contains the silver molybdate and the zinc molybdate, the silver molybdate and the zinc molybdate can be a mixture at any ratio, provided the total amount of both compounds is about 0.1-0.3 wt %. The silver molybdate and the zinc molybdate can be in the form of granules. The granule can comprise silver molybdate, zinc molybdate, or both of the compounds. Preferably, the granule contains only one compound. The granules can have a particle diameter of about 1-300 nm. Preferably, the particle diameter is about 1-100 nm.

The present disclosure also provides a method for preparing the enamel composition. The method comprises: mixing zinc oxide, diboron trioxide, zirconium dioxide, silicon oxide, sodium oxide, barium oxide, lithium oxide, aluminum oxide or aluminum oxide precursor compounds that can be converted into aluminum oxide by sintering, and calcium oxide or calcium oxide precursor compounds that can be converted into calcium oxide by sintering. The method can optionally comprise a step of grinding the components into granules. The grinding process can use any suitable methods. Preferably, the grinding process provides granules with a particle diameter of about 1-300 nm. Preferably, the grinding process provides granules with a particle diameter of about 1-100 nm. The mixing method can be any suitable mixing method that can mix the composition uniformly. The grinding process and the mixing process can be performed simultaneously. For example, a ball mill can be used to grind and mix the composition. The weight ratio of grinding material to grinding medium is about (2-4):1. The rotate speed is about 250-320 r/min. The grinding time is about 180-350 hours.

The enamel composition is an alkali-boron-silica glass material. The enamel composition can be applied and sintered onto a metallic substrate, forming an enamel layer.

The present disclosure also provides a coated product using the enamel composition of the present disclosure. The coated product comprises a substrate and an enamel layer on the substrate. The enamel layer comprises zinc oxide, diboron trioxide, zirconium dioxide, silicon oxide, sodium oxide, barium oxide, lithium oxide, at least one of aluminum oxide and aluminum oxide precursor compounds that can be converted into aluminum oxide by sintering, and at least one of calcium oxide and calcium oxide precursor compounds that can be converted into calcium oxide by sintering.

Based on the total amount of the oxides, the zinc oxide is about 5-8.5 wt %, the diboron trioxide is about 2.5-6.5 wt %, the zirconium dioxide is about 2.6-4.2 wt %, the silicon oxide is about 49-68 wt %, the sodium oxide is about 3.6-10.2 wt %, the barium oxide is about 6-10.5 wt %, the lithium oxide is about 2-10.5 wt %, the aluminum oxide is about 5.6-11 wt %, and the calcium oxide is about 1.8-3.6 wt %.

The enamel layer can further comprise at least one of silver molybdate and zinc molybdate. Based on the total amount of the oxides, the total content of the silver molybdate and the zinc molybdate is 0.1-0.3 wt %. Since the decomposition temperature of silver molybdate and zinc molybdate is above 1000° C., obviously higher than the sintering temperatures of about 400-600° C., the silver molybdate and the zinc molybdate exist as molybdate species in the enamel layer.

The enamel layer may further comprise other metal oxides. As known in the art, some metal oxides can adjust the color of the enamel layers. For example, the enamel layer containing cobalt oxides is blue. The enamel layer containing copper oxides is green or red. The enamel layer containing chromium oxides is dark green. The enamel layer containing ferric oxide is dark red. As known to those skilled in the art, based on the total amount of the oxides, the metal oxides can be about 0.1-2.5 wt %. The addition of the metal oxides may provide a vivid, dense, and fade-resistant color for the coated product.

The enamel layer can have any suitable thickness. Preferably, the enamel layer has a thickness of about 20-120 μm.

The substrate can be any suitable metal or alloy. The examples include stainless steel, titanium alloys, magnesium alloys, zinc alloys, aluminum alloys, and combinations thereof.

The present disclosure provides a method for preparing a coated product. The method comprises: applying an enamel composition onto a surface of a substrate; and sintering the enamel composition to form an enamel layer on the substrate. The enamel layer comprises zinc oxide, diboron trioxide, zirconium dioxide, silicon oxide, sodium oxide, barium oxide, lithium oxide, aluminum oxide, and calcium oxide.

When the enamel composition comprises a liquid carrier, the method further comprises a step of: evaporating the liquid carrier before sintering. Preferably, the evaporating process is performed at a temperature of about 150-200° C. for about 1-2 hours.

The sintering can be performed at any suitable temperature for a sufficient time to provide the enamel layer. Preferably, the sintering temperature is about 400-600° C., and the sintering time is about 0.5-2 hours.

The applying process of the enamel layer on the substrate can further comprise: placing the substrate in an electrophoretic suspension; connecting the substrate with an anode of a power supply electrically; connecting a conductive material with a cathode of the power supply electrically; connecting the conductive material with the electrophoretic suspension electrically; and depositing an enamel composition on the surface of the substrate by electrophoresis.

The electrophoretic suspension comprises an enamel composition and a liquid carrier. The enamel composition comprises zinc oxide, diboron trioxide, zirconium dioxide, silicon oxide, sodium oxide, barium oxide, lithium oxide, at least one of aluminum oxide and aluminum oxide precursor compounds that can be converted into aluminum oxide by sintering, and at least of calcium oxide and calcium oxide precursor compounds that can be converted into calcium oxide by sintering. The oxides of the enamel composition can be in various forms. Preferably, the oxides are in the form of particles that are easily mixed. More preferably, the oxides are in the form of granules. Preferably, some of the granules comprise one or more than one of the compounds. Preferably, the electrophoretic suspension has a concentration of the composition at about 150-250 g/L. The liquid carrier can be any suitable liquid. The exemplary liquids include water and ethanol. Alcohols are preferred liquid carriers. Preferably, absolute ethyl alcohol is used. The binding force, the wear-resistance and the corrosion-resistance of the enamel materials may be improved, and the surface roughness of the enamel materials may be decreased.

The conductive material can be any suitable electrically conductive material. The exemplary material is selected from the group consisting of copper, stainless steel, lead, platinum-rhodium alloy, and combinations thereof. Copper is a preferred conductive material.

The electrophoretic condition comprises: an electrophoretic temperature is about 20-25° C., an electrophoretic time is about 3-55 seconds, an electrophoretic voltage is about 21-25 voltages, and a distance between the substrate and the conductive material is about 2-4 centimeters.

### EXAMPLES

Preparation of the Enamel Compositions and Coated Products

### Example 1

An enamel composition and a coated product of the present disclosure are illustrated in this example.

(1) Preparation of the Enamel Composition

5.6 kg aluminum oxide, 7.8 kg zinc oxide, 2.5 kg diboron trioxide, 1.8 kg calcium oxide, 2.6 kg zirconium dioxide, 67.9 kg silicon oxide, 3.6 kg sodium oxide, 6 kg barium oxide, 2.1 kg lithium oxide and 0.1 kg silver molybdate were added into a planetary ball mill. Then the mixture was milled at a rotate speed of about 250 r/min. The weight ratio of the mixture to the grinding medium was about 2:1. After grinding for about 350 hours, a composition was obtained. The particle diameter of the granule was about 1-100 nm.

(2) Preparation of the Coated Product

A stainless steel substrate (Model 304) was electrically connected with the anode of a power supply. A copper block was electrically connected with the cathode of the power supply. Then about 80 kg of the prepared composition was mixed with about 444 L of absolute ethyl alcohol uniformly to provide an electrophoretic suspension. The concentration of the composition was about 180 g/L. The substrate was placed in the electrophoretic suspension. The copper block was connected to the electrophoretic suspension. The voltage of the power supply was adjusted to about 21 volts. The distance between the substrate and the copper block was about 2 cm. Then the enamel composition was deposited on the surface of the substrate by electrophoresis at about 20° C. for about 3 seconds.

The coated stainless steel was then dried at about 150° C. for about 2 hours, followed by sintering at about 400° C. for about 2 hours.

The coated stainless steel was cooled to about 50° C. in the air. The thickness of the enamel layer was measured by a microscope (Model DMM-660D, made by Shanghai CaiKang Instrument Limited Company). The enamel layer had a thickness of about 20 μm. The coated product was assigned as A1.

### Example 2

A composition and a coated product of the present disclosure are illustrated in this example.

(1) Preparation of the Enamel Composition

8 kg aluminum oxide, 8.5 kg zinc oxide, 6.2 kg diboron trioxide, 3.8 kg calcium oxide, 4.2 kg zirconium dioxide, 49 kg silicon oxide, 7.2 kg sodium oxide, 8 kg barium oxide, 5 kg lithium oxide, 0.1 kg silver molybdate, and 0.2 kg zinc molybdate were added into the planetary ball mill. Then the mixture was milled at a rotate speed of about 280 r/min. The weight ratio of the mixture to the grinding medium was about 3:1. After grinding for about 280 hours, an enamel composition was obtained. The particle diameter of the granule was about 1-100 nm.

(2) Preparation of the Coated Product

The titanium alloy substrate (Model TA2) was electrically connected with the anode of a power supply. A copper block was electrically connected with the cathode of the power supply. About 80 kg of the above prepared composition was mixed with about 400 L absolute ethyl alcohol uniformly to provide an electrophoretic suspension. The concentration of the composition was about 200 g/L. The substrate was placed in the electrophoretic suspension. The copper block was connected to the electrophoretic suspension. The voltage of the power supply was adjusted to about 23 volts. The distance between the substrate and the copper block was about 3 cm. Then the enamel composition was deposited on the surface of the substrate by electrophoresis at about 23° C. for about 35 seconds.

The coated titanium alloy was then dried at about 180° C. for about 1.5 hours, followed by sintering at about 500° C. for about 1 hour.

The coated titanium alloy was cooled to about 50° C. in the air. The thickness of the enamel layer was measured by a Model DMM-660D microscope (Shanghai CaiKang Instrument Limited Company). The enamel layer had a thickness of about 70 μm. The coated product was assigned as A2.

### Example 3

A composition and a coated product of the present disclosure are illustrated in this example.

(1) Preparation of the Enamel Composition

12.5 kg bauxite (which is equivalent to 9 kg aluminum oxide), 5 kg zinc oxide, 25 kg diboron trioxide, 2.38 kg calcium hydroxide (which is equivalent to 1.8 kg calcium oxide), 2.6 kg zirconium dioxide, 53.3 kg quartz sand (which is equivalent to 53.1 kg silicon oxide), 8 kg sodium oxide, 9 kg barium oxide, 8.8 kg lithium oxide, and 0.2 kg zinc molybdate were added into a planetary ball mill. The mixture was milled at a rotate speed of about 320 r/min. The weight ratio of the mixture to the grinding medium was about 4:1. After grinding for 180 hours, a composition was obtained. The particle diameter of the granule was about 1-100 nm.

(2) Preparation of the Coated Product

A magnesium alloy substrate (Model AZ91) was electrically connected with the anode of a power supply. A copper block was electrically connected with the cathode of the power supply. About 80 kg of the above prepared composition was mixed with about 364 L of absolute ethyl alcohol uniformly to provide an electrophoretic suspension. The concentration of the composition was about 220 g/L. The substrate was placed in the electrophoretic suspension. The copper block was connected to the electrophoretic suspension. The voltage was adjusted to about 25 volts. The distance between the substrate and the copper block was about 4 cm. Then the enamel composition was deposited on the surface of the substrate by electrophoresis at about 25° C. for about 55 seconds.

The coated magnesium alloy was then dried at about 200° C. for 1 hour, and followed by sintering at about 600° C. for about 0.5 hour.

The coated magnesium alloy was cooled down to about 50° C. in the air. The thickness of the enamel layer was measured by a Model DMM-660D microscope (Shanghai CaiKang Instrument Limited Company). The enamel layer has a thickness of about 120 μm. The coated product was assigned as A3.

### Example 4

A composition and a coated product of the present disclosure are illustrated in this example.

The composition and the coated product were prepared according to the method described in Example 1. A zinc alloy substrate (made by BYD Company Limited) was used instead of stainless steel substrate.

The thickness of the enamel layer was measured using a Model DMM-660D microscope (made by Shanghai CaiKang Instrument Limited Company). The enamel layer had a thickness of about 20 μm. The coated product was assigned as A4.

### Example 5

An enamel composition and a coated product of the present disclosure are illustrated in this example.

The enamel composition and the coated product were prepared according to the method described in Example 1. An aluminum alloy substrate (Model 3003) was used instead of stainless steel substrate.

The thickness of the enamel layer was measured using a Model DMM-660D microscope (made by Shanghai CaiKang Instrument Limited Company). The enamel layer had a thickness of about 20 μm. The coated product was assigned as A5.

### Example 6

An enamel composition and a coated product of the present disclosure are illustrated in this example.

The enamel composition and the coated product were prepared according to the method described in Example 1. Silver molybdate was not used during the preparation of the enamel composition.

The thickness of the enamel layer was measured using a Model DMM-660D microscope (made by Shanghai CaiKang Instrument Limited Company). The enamel layer had a thickness of about 20 μm. The coated product was assigned as A6.

### Example 7

A composition and a coated product of the present disclosure are illustrated in this example.

The composition and the coated product were prepared according to the method described in Example 1. Instead of absolute ethyl alcohol, about 444 L of water was used to prepare the electrophoretic suspension. The concentration of the composition was about 180 g/L.

The thickness of the enamel layer was measured using a Model DMM-660D microscope (made by Shanghai CaiKang Instrument Limited Company). The enamel layer had a thickness of about 20 μm. The coated product was assigned as A7.

### Example 8

An enamel composition and a coated product of the present disclosure are illustrated in this example.

The enamel composition and the coated product were prepared according to the method described in Example 2. The coated titanium alloy was sintered at about 400° C. for about 2 hours without drying.

The thickness of the enamel layer was measured using a Model DMM-660D microscope (made by Shanghai CaiKang Instrument Limited Company). The enamel layer had a thickness of about 70 μm. The coated product was assigned as A8.

Control 1

An enamel composition and a coated product in the known art are illustrated in this example.

8 kg aluminum oxide, 8.5 kg zinc oxide, 4.3 kg diboron trioxide, 3.6 kg calcium oxide, 4.2 kg zirconium dioxide, 3.6 kg sodium oxide, 1.0 kg ceria, 2.0 kg magnesium nitrate, 12.2 kg zirconium sulfate, 5.2 kg sodium borate, 47.4 kg gross silicon, and other impurity were added into a planetary ball mill. The mixture was milled at a rotate speed of about 250 r/min. The weight ratio of the mixture to the grinding medium was about 2:1. After grinding for about 350 hours, a composition was obtained. The granules had a particle diameter of about 1-100 nm.

The coated product was prepared according to the method described in Example 8.

The thickness of the enamel layer was measured using a Model DMM-660D microscope (made by Shanghai CaiKang Instrument Limited Company). The enamel layer had a thickness of about 70 μm. The coated product was assigned as AC1.

Control 2

An enamel composition and a coated product in the known art are illustrated in this example.

The composition and coated product were prepared according to the method described in Example 8.

8 kg aluminum oxide, 8.5 kg zinc oxide, 4.3 kg diboron trioxide, 3.6 kg calcium oxide, 4.2 kg zirconium dioxide, 3.6 kg sodium oxide, 5 kg Lithium dioxide, 1.0 kg ceria, 2.0 kg magnesium nitrate, 12.2 kg zirconium sulfate, 5.2 kg sodium borate, 42.4 kg gross silicon, and other impurity were added into a planetary ball mill. The weight ratio of the mixture to the grinding medium was about 2:1. After grinding for about 350 hours, an enamel composition was obtained. The granules had a particle diameter of about 1-100 nm.

The thickness of the enamel layer was measured by a Model DMM-660D microscope (made by Shanghai CaiKang Instrument Limited Company). The enamel layer had a thickness of about 70 μm. The coated product was assigned as AC2.

Properties of the Enamel Layer

Adhesive strength, wear-resistance, corrosion-resistance, and surface roughness were evaluated for the coated products A1-A8 and control samples AC1 and AC2.

(1) Adhesion Testing

Using a cutting device and cutting guide, cuts were made into the enamel layer to a depth sufficient to expose the substrate. Each cutting line had a width of about 1 millimeter. The cuts formed 100 squares with similar sizes. During the cutting, some enamel of the squares peeled off. The number of squares without enamel was referred to “N1”, as an indication of the quality of the adhesion. The lower the number, the better the quality of the enamel. The adhesive strength of the enamel layer was further tested by a tape test. A transparent tape with a width of 24 mm (Model 600 sellotape, made by 3M Company) was applied onto the aforementioned cutting area. The tape was adhered closely onto the surface of the coated product for five minutes. Then the tape was removed by a force perpendicular to the surface of the enamel. The number of the squares whose enamel peeled off was recorded, referred to “N2”. The percentage of the remaining enamel squares were used to indicate the adhesive strength of the enamel layer. The percentage of the remaining enamel squares equals 100−(N1+N2). The larger the percentage of the enamel, the stronger the adhesion of the enamel layer. The evaluating results are shown in Table 1.

(2) Wear-Resistance Testing

The coated products of examples A1-A8 and control examples AC1 and AC2 were oscillated and milled in an oscillating mill for 2 hours. Then the enamel layers were examined. The results are showed in Table 1.

(3) Corrosion-Resistance Testing

The corrosion-resistance capability was evaluated by salt spray test. The coated products were placed in a salt-mist corrosion test chamber (Model YWX/Q-250, made by Shanghai SUNAN Test Equipment Limited Company). Sodium chloride suspension was sprayed on the coated products at about 35° C. for about 2 hours. The concentration of the sodium chloride suspension was about 5 wt %. Then the coated products were placed in a temperature humidity chamber with a temperature of about 40° C. and a relative humidity of about 80%. The time course over which the enamel layer became abnormal was used to indicate the corrosion-resistance capability. The longer the time, the better the enamel. The test results are shown in Table 1.

(4) Surface Roughness Testing

The surface roughness was tested by a surface roughness tester (Model JB-3C, made by Shanghai CAIKANG Optical Instrument Limited Company). The tracer tip of the instrument moved on the surface of the coated products for a certain distance. Peaks and valleys were recorded and converted into a value of a given parameter by a microprocessor, which was displayed on an indicator gauge. The parameter “Ra”, defined as the arithmetic average roughness, was used to indicate the surface roughness. The lower the Ra value, the smoother the surface. The test results are shown in Table 1.

TABLE 1

| | Remaining | | | |
|---|---|---|---|---|
| | Enamel | | Corrosion- | Surface |
| Sam- | Squares | | Resistance | Roughness |
| ples | (%) | Wear-Resistance | (hours)^{a} | Ra |
| A1 | 100 | No peeling off on the corners, | 240 | 0.5 |
| | | edges and the surface | | |
| A2 | 100 | No peeling off on the corners, | 240 | 0.5 |
| | | edges and the surface | | |
| A3 | 100 | No peeling off on the corners, | 240 | 0.5 |
| | | edges and the surface | | |
| A4 | 100 | No peeling off on the corners, | 240 | 0.5 |
| | | edges and the surface | | |
| A5 | 100 | No peeling off on the corners, | 240 | 0.5 |
| | | edges and the surface | | |
| A6 | 99 | No peeling off on the corners, | 230 | 0.5 |
| | | edges and the surface | | |
| A7 | 97 | No peeling off on the corners, | 220 | 0.5 |
| | | edges and the surface | | |
| A8 | 97 | No peeling off on the corners, | 220 | 0.5 |
| | | edges and the surface | | |
| AC1 | 70 | Obvious peeling off on the | 70 | 2.0 |
| | | corners and edges, slight | | |
| | | peeling off on the surface | | |
| AC2 | 75 | Obvious peeling off on the | 80 | 1.6 |
| | | corners and edges, slight | | |
| | | peeling off on the surface | | |

^{a}the time course over which the abnormality of the enamel layer occurred.

For the coated products A1-A8, 97-100% of the enamel remained in the adhesive strength test. In the wear-resistance test, the enamel layer stayed intact. The time course over which the abnormality of the enamel layers occurred was about 220-240 hours in the corrosion-resistance test. According to the surface roughness testing results, the average roughness Ra was about 0.5. For the control samples AC1-AC2, 70-75% of the enamel remained in the adhesive strength test. The obvious peeling off of the enamel layer at the corners and edges was observed. The enamel layer on the surface also peeled off slightly. The time course over which the abnormality of the enamel layers occurred was about 70-80 hours. According to the surface roughness testing results, the Ra value of the control samples was about 1.6-2.0.

Therefore, comparing to the control samples, the coated products A1-A8 in the present disclosure had better binding force, wear-resistance, corrosion-resistance, and less rough surfaces.

Many modifications and other embodiments of the present disclosure will come to mind to one skilled in the art to which the present disclosure pertains having the benefit of the teachings presented in the foregoing description. It will be apparent to those skilled in the art that variations and modifications of the present disclosure can be made without departing from the scope or spirit of the present disclosure. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

We claim:

1. An enamel composition comprising zinc oxide, diboron trioxide, zirconium dioxide, silicon oxide, sodium oxide, barium oxide, lithium oxide, at least one of aluminum oxide and aluminum oxide precursor compounds that form aluminum oxide upon sintering, and at least one of calcium oxide and calcium oxide precursor compounds that form calcium oxide upon sintering.

2. The composition of claim 1, wherein the zinc oxide is about 5-8.5 wt %, the diboron trioxide is about 2.5-6.5 wt %, the zirconium dioxide is about 2.6-4.2 wt %, the silicon oxide is about 49-68 wt %, the sodium oxide is about 3.6-10.2 wt %, the barium oxide is about 6-10.5 wt %, the lithium oxide is about 2-10.5 wt %, the total amount of the aluminum oxide from either aluminum oxide or the aluminum oxide precursor compounds is about 5.6-11 wt %, and the total amount of the calcium oxide from either calcium oxide or the calcium oxide precursor compounds is about 1.8-3.6 wt %.

3. The composition of claim 1, wherein the zinc oxide, the diboron trioxide, the zirconium dioxide, the silicon oxide, the sodium oxide, the barium oxide, the lithium oxide, the aluminum oxide or the aluminum oxide precursors, and the calcium oxide or the calcium oxide precursors are in the form of granules; and wherein the granule comprises one or more than one of the compounds.

4. The composition of claim 3, wherein the granules have a particle diameter of about 1-300 nm.

5. The composition of claim 1, further comprising at least one of silver molybdate and zinc molybdate.

6. The composition of claim 5, wherein the total amount of the silver molybdate and zinc molybdate is about 0.1-0.3 wt %.

7. A coated product comprising:
a substrate having a surface; and
an enamel layer on the surface of the substrate, the enamel layer comprising zinc oxide, diboron trioxide, zirconium dioxide, silicon oxide, sodium oxide, barium oxide, lithium oxide, aluminum oxide, and calcium oxide.

8. The coated product of claim 7, wherein the zinc oxide is about 5-8.5 wt %, the diboron trioxide is about 2.5-6.5 wt %, the zirconium dioxide is about 2.6-4.2 wt %, the silicon oxide is about 49-68 wt %, the sodium oxide is about 3.6-10.2 wt %, the barium oxide is about 6-10.5 wt %, the lithium oxide is about 2-10.5 wt %, the aluminum oxide is about 5.6-11 wt %, and the calcium oxide is about 1.8-3.6 wt %.

9. The coated product of claim 7, wherein the enamel layer further comprises at least one of silver molybdate and zinc molybdate.

10. The coated product of claim 7, wherein the substrate is selected from the group consisting of stainless steel, titanium alloys, magnesium alloys, zinc alloys, aluminum alloys, and combinations thereof.

11. The coated product of claim 7, wherein the enamel layer has a thickness of about 20-120 μm.

12. A method for coating a product comprising:
applying an enamel composition to a surface of a substrate; and
sintering the enamel composition to form an enamel layer on the substrate;
wherein the enamel layer comprises zinc oxide, diboron trioxide, zirconium dioxide, silicon oxide, sodium oxide, barium oxide, lithium oxide, aluminum oxide, and calcium oxide.

13. The method of claim 12, wherein the enamel composition comprises a liquid carrier and further wherein the liquid carrier is evaporated before sintering.

14. The method of claim 12, wherein the sintering is at a temperature of about 400-600° C.

15. The method of claim 12, wherein in the enamel layer, the zinc oxide is about 5-8.5 wt %, the diboron trioxide is about 2.5-6.5 wt %, the zirconium dioxide is about 2.6-4.2 wt %, the silicon oxide is about 49-68 wt %, the sodium oxide is about 3.6-10.2 wt %, the barium oxide is about 6-10.5 wt %, the lithium oxide is about 2-10.5 wt %, the aluminum oxide is about 5.6-11 wt %, and the calcium oxide is about 1.8-3.6 wt %.

16. The method of claim 12, wherein the enamel composition further comprises at least one of silver molybdate and zinc molybdate.

17. The method of claim 12, wherein the applying comprises:
placing the substrate in an electrophoretic suspension;
connecting the substrate with an anode of a power supply electrically;
connecting a conductive material with a cathode of the power supply electrically;
connecting the conductive material with the electrophoretic suspension electrically; and
depositing an enamel composition on the surface of the substrate by electrophoresis.

18. The method of claim 17, wherein the electrophoretic suspension comprises an enamel composition and a liquid carrier; and
wherein the enamel composition comprises zinc oxide, diboron trioxide, zirconium dioxide, silicon oxide, sodium oxide, barium oxide, lithium oxide, at least one of aluminum oxide and aluminum oxide precursor compounds that form aluminum oxide upon sintering, and at least one of calcium oxide and calcium oxide precursor compounds that form calcium oxide upon sintering.

19. The method of claim 18, wherein the electrophoretic suspension has a concentration of the enamel composition at about 150-250 g/L.

20. The method of claim 18, wherein the liquid carrier is water or ethanol.
